(19) United States
(12) Patent Application Publication
(10) Pub. No.: US 2002/0010728 A1
(43) Pub. Date: Jan. 24, 2002

(54) Processor for FIR filtering

(76) Inventor: Robert William Stoye, Cambridge (GB)

Correspondence Address: PENNIE AND EDMONDS, 1155 AVENUE OF THE AMERICAS, NEW YORK, NY, 100362711

(21) Appl. No.: 09/767,987

(22) Filed: Jan. 23, 2001

(30) Foreign Application Priority Data
Jun. 20, 2000 (GB) GB0015129.0

(51) Int. Cl. G06F 17/10

(52) U.S. Cl. 708/319

(57) ABSTRACT

A method and processor for FIR filtering a series of real input values with a series of filter coefficients where each of the input values is loaded from memory into the processor, and the processor employs each loaded input value in computing more than one filter output value at a time, whereby the amount of data which needs to be transferred between memory and the processor is substantially reduced. The filter output values are preferably real data values, although the invention could be adapted to operate on complex number pairs. More than one input value can be loaded from memory in each clock cycle. Computations can be made by a multiply-and-accumulate unit, within a filtering unit with dedicated hardware within the processor, or by a general-purpose digital signal processor (DSP). By using existing units within the processor, little or no modification is required to the processor in order to achieve a substantially improved performance.

This invention relates to a method of FIR filtering and a processor for FIR filtering. The processor can be used in a network adaptor, computer or modem.

As known in the art, FIR (Finite Impulse Response) filters are used to manipulate discrete data sequences in a systematic and flexible fashion in order to achieve some required effect, for example, changing a sampling rate, removing noise, extracting information, etc. (In the examples of the invention described below, an FIR filter implemented in a processor is used as a downsample or decimation filter, and an upsample or interpolation filter, but other uses will be apparent to those skilled in the art.)

In a conventional implementation of an FIR filter using a digital signal processor, each output value is computed as the sum of each of the n filter coefficients multiplied by a corresponding input (sample) value. The input values, output values and filter coefficients, stored in memory, are transferred between memory and the processor when required by the processor. In the processor, all that is required to compute each filter output value is one multiplier, to multiply input values with the filter coefficients; and one accumulator, to sum and hold the cumulative results of such multiplications. Each output value can then be read from the accumulator as the requisite multiplications are completed.

A disadvantage of this known FIR filtering technique is that limits are imposed by the memory system, because only a limited number of values can be transferred between memory and the processor in a given amount of time (more specifically, during each clock cycle of the processor). This can impose severe restrictions on the number of filter coefficients which can be used in the computations, or on the number of input samples which can be processed in a given amount of time (or during each clock cycle of the processor). This in turn can impose design limitations on time-critical applications which would otherwise benefit from more rapid processing of digital samples, for example, as with high data throughput in ADSL communications. Trying to solve this problem by increasing the available memory bandwidth can be both difficult and expensive. Increasing the clock speed of the processor may also not provide a solution, because the problem is not occurring in the processor itself, but it is due to the way data needs to be fetched from memory for the purpose of computation.

As an alternative, an FIR filter may be constructed in hardware using delay registers and hard-coded filter coefficients. For large numbers of coefficients, such filters are far more expensive because a coefficient stored in RAM takes far less silicon than a coefficient stored in registers. Therefore, such a hardware alternative in shift registers and discrete logic is far more expensive than RAM and processors for more than a very small number of coefficients.

An example of multiplying and accumulating values within a processor is given in U.S. Pat. No. 5,983,257 which relates to a computer system that includes a multimedia input device which generates an audio or video input signal and a processor coupled to the multimedia input device. The system further includes a storage device coupled to the processor and having stored therein a signal processing routine for multiplying and accumulating input values representative of the audio or video input signal. However, this system depends on executing packed data operations and although an implementation of an FIR filter is described, only one filter output is calculated at a time, and so the memory system is required to fetch N*M values for N coefficients over M output values.

U.S. Pat. No. 5,983,256 is directed to a method and apparatus for including in a processor instructions for performing multiply-add operations on packed data, and U.S. Pat. No. 5,793,661 discloses a method of multiplying and accumulating two sets of values in a computer system, where a packed multiply add is performed on a portion of a first set of values packed into a first source and a portion of a second set of values packed into a second source to generate a result. U.S. Pat. No. 5,835,392 relates to a method in a computer system of performing a butterfly stage of a complex fast fourier transform of two input signals, which includes the step of performing a packed multiply add on packed complex value generated from an input signal and a set of trigonometric values. U.S. Pat. No. 5,941,940 is directed to a digital signal processor architecture which is also adapted for performing fast Fourier Transform algorithms.

The present invention provides a method of FIR filtering a series of real input values with a series of filter coefficients using a processor, the method comprising the steps of (a) loading each of the input values from memory into the processor, and (b) employing each of the loaded input values in the computation by the processor of more than one filter output value at a time, whereby the amount of data which needs to be transferred between memory and the processor is substantially reduced.

The filter output values are preferably real data values, although the invention could be adapted to operate on complex number pairs.

For example, in the simplest case where two output values are calculated at a time, the surprising result is that, for a given FIR filtering operation, the amount of data in total which needs to be loaded between memory and the processor is halved; by calculating more output values at a time, even less data needs to be transferred. Reducing the fetch rate from memory can therefore reduce the cost of a given filtering system, as less expensive memory and other sub-systems can be used.

The method preferably comprises the step of loading more than one input value from memory in each clock cycle, and preferably also comprises the step of furthering the calculation of more than one output value in each clock cycle.

For the avoidance of doubt, a “clock cycle” refers to one period of the clock signal which is used to synchronize the internal operation of the processor.

Preferably,. the method includes the step of computing each output value by accumulating the results of at least one calculation.

In practice, computations can be made by a multiply-and-accumulate unit, within a filtering unit with dedicated hardware within the processor, or by a general-purpose digital signal processor (DSP). By using existing units within the processor, little or no modification is required to the processor in order to achieve a substantially improved performance. The added advantage is provided that the multiply/add facility may be used for other calculations.

The method of the present invention can include the step of multiplying each input value with more than one filter coefficient and adding the result of each multiplication to accumulators corresponding to more than one output value. Only one value (input value or filter coefficient) need be loaded from memory for every multiplication performed during the filtering operation.

An embodiment of the invention uses, for example, 4 multipliers, 2 adders, and data buses to feed them, with purpose of performing FIR filtering at 4 MACs/cycle (where MAC=multiply and accumulate). This would normally require a memory system which can fetch 8 values per cycle, but the latter embodiment of the invention achieves it with a memory system which need only fetch 4 values/cycle.

By providing more multipliers in the processor, more output values can be simultaneously computed for a given number of fetches from memory. For example, with 8 digital values fetched from memory each cycle and 8 multipliers, 4 output values can be computed at a time.

Greater efficiency is obtained by reusing the same filter coefficient for more than one input value, since more can be done during one clock cycle.

Output values may be consecutive. Depending on the nature of the filtering operation, the output values may also be computed in non-consecutive order. However, the greatest reuse of filter coefficients, and hence optimal performance, is typically achieved by computing consecutive output values at a time.

The method of the invention can include the steps of (a) feeding one or more memory-loaded filter coefficients into a respective delay register, and (b) using the output of the delay register as the input to the multiply-and-accumulate (MAC) unit.

The loaded filter coefficient is preferably delayed by one clock cycle before being input into the multiply-and-accumulate unit, whilst also being fed into another multiply-and-accumulate unit without a delay. Thus, one filter coefficient may be used in more than one multiplication during more than one clock cycle.

The use of a delay register allows the loaded filter coefficient to be reused without needing to reload it from memory.

Additionally, the output of the multiply-and-accumulate unit can be pipelined, and preferably the input to the accumulator stage is also pipelined. By pipelining the output of the accumulator stage, the amount of startup or cooldown time required of the multiply-and-accumulate pipeline can be reduced.

When using FIRs at say 4 MACs/cycle, the overheads of a next loop out start to become very significant, particularly if the multipliers themselves are heavily pipelined (to achieve high clock speeds). The next-loop-out overheads are involved every time the computation of output values is completed by the processor.

Typically, two output values may be computed at a time, although equally, more than two output values may be computed at a time, giving a further reduction in the number of input values which need to be loaded for a given FIR filtering operation.

It is particularly convenient to calculate two output values at a time, as the processor may then easily be adapted to perform complex number arithmetic.

The method may further comprise the step of downsampling the input values. The downsampling, or decimation, of the input values results in fewer output values than input values.

By applying the present invention to a downsampling process, fewer input values need to be loaded from memory, and consequently less memory bandwidth is required.

At least one further delay register may be used. For example, for a 2:1 decimation, one extra delay register is needed (two delay registers in total). For a 4:1 decimation, a further two delay registers are needed (four delay registers in total), and so on.

In applying the invention as a decimation filter, pipeline registers could be connected to the digital input so as to operate at the same rate. However, the locality of the re-used coefficients would not then be nearly as convenient as with a normal 1:1 FIR. For example, to do 2:1 decimation, 1 extra delay register (scalar width) would be needed. To do 4:1 efficiently, 3 extra delay registers would be needed.

The method scales to larger decimation factors, but startup/cooldown costs for each pair of output values gradually increases, reducing the aggregate throughput. To avoid this problem, an embodiment of the invention includes further delay registers connected to the inputs to the multipliers, whereby the basic FIR filter can achieve 2: 1, 3:1 or 4:1 downsample (decimation) at 4 MACs/cycle with very little overhead.

Alternatively, the method of the invention can include the step of upsampling the input values.

The upsampling (or interpolation filtering) of the input values results in more output values than input values. Upsampling is a more complicated process than downsampling, and requires substantially more filter coefficients per input value. By reusing the upsampling coefficients, upsampling may be performed more quickly.

The more than one output values computed at a time may be separated by a number of samples corresponding to the upsampling factor.

For example, a 16:1 upsampling filter has an upsample factor of 16, and the first and seventeenth output value might be computed at a time, followed by the second and eighteenth output value, etc.

By computing non-consecutive output samples at a time, the invention can be applied to upsampling filters exactly as for regular filters so that gains in the efficiency of the memory system are realised.

In accordance with one aspect of the present invention, a processor for FIR filtering a stream of real input values with a series of coefficients comprises a plurality of accumulators corresponding to a plurality of filter output values; means for loading each of the input values and coefficients from memory; means for performing simultaneous multiplications of the input value with at least some of the coefficients, and means for adding the results of the multiplications to the respective accumulators. Each loaded input value is used in the calculation of more than one filter output.

According to another aspect, a processor for FIR filtering a stream of real input values with a series of coefficients comprises at least two pairs of multipliers; at least one pair of adders, each adder connected to the outputs of one pair of multipliers; at least one pair of accumulators, each accumulator corresponding to a filter output value and connected to the output of one of the adders; and at least one delay register connected to the input of one of the multipliers, the delay register being connected to one of the multipliers. The input values are fed into the multipliers and delay register.

Another aspect relates to a processor comprising a memory interface; at least two pairs of multipliers; at least one pair of adders, each adder connected to the outputs of one pair of multipliers; at least one pair of accumulators, each accumulator corresponding to a filter output value and connected to the output of one of the adders; and at least one delay register connected to the input of one of the multipliers, the delay register being connected to one of the multipliers. The memory interface is adapted to load input samples from memory into the inputs of the multipliers and the input of the delay register and store the output of the accumulators back in memory.

The output of the accumulators may be pipelined, as also may the inputs of the multipliers, adders and/or accumulators.

Also, the processors may further comprise a variable-delay FIFO buffer connected to the input of at least one of the multipliers. The processor may also further comprise a second delay register, and may also downsample the input stream. Alternatively, the processors may upsample the input stream.

The invention can also be embodied in a substrate having recorded thereon information in computer readable form for performing any of the above methods.

The invention can further be embodied in a network adaptor, a computer, or modem.

An embodiment of the invention will now be described with reference to the accompanying drawings, in which:

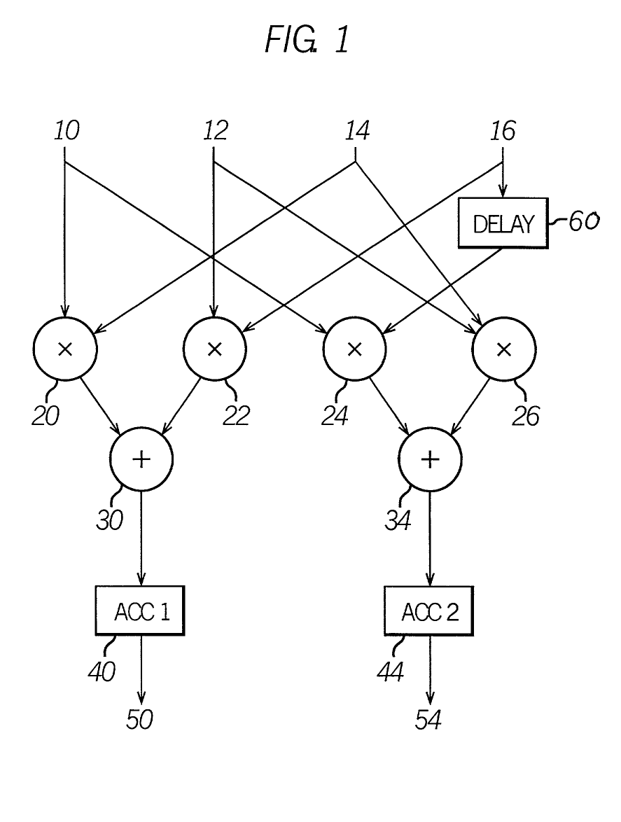

FIG. 1 shows in overview the core processing unit of an embodiment;

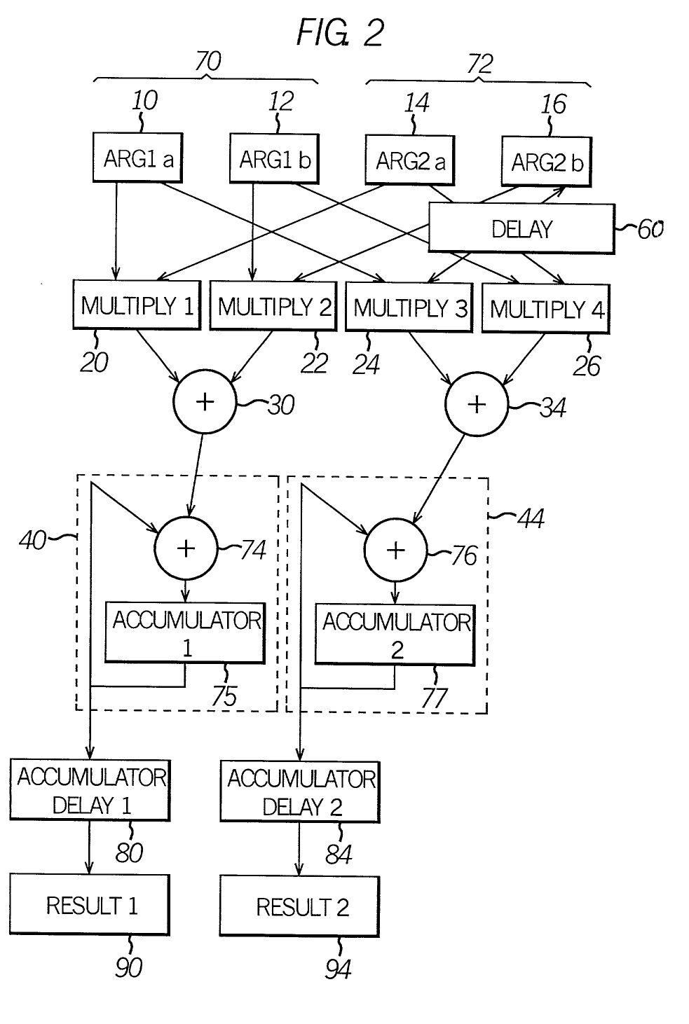

FIG. 2 shows in more detail the arrangement of the core processing unit for a 4 MAC/cycle system;

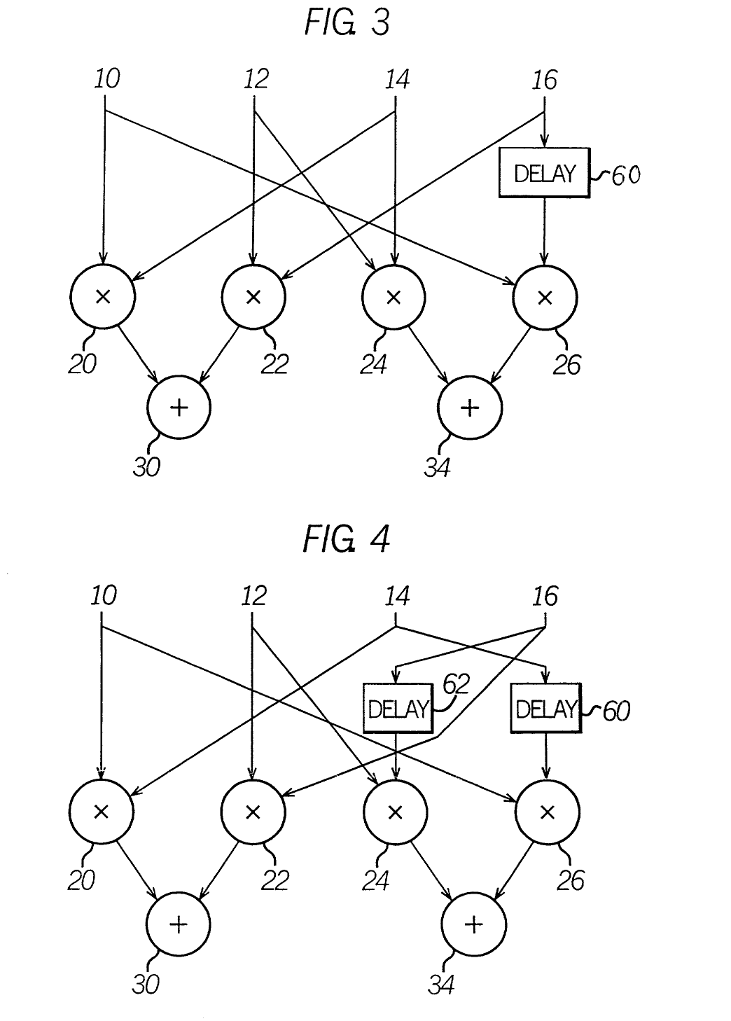

FIG. 3 shows an alternative arrangement of part of the core processing unit for a 4 MAC/cycle system;

FIG. 4 shows part of the core processing unit for a 2:1 downsample filter;

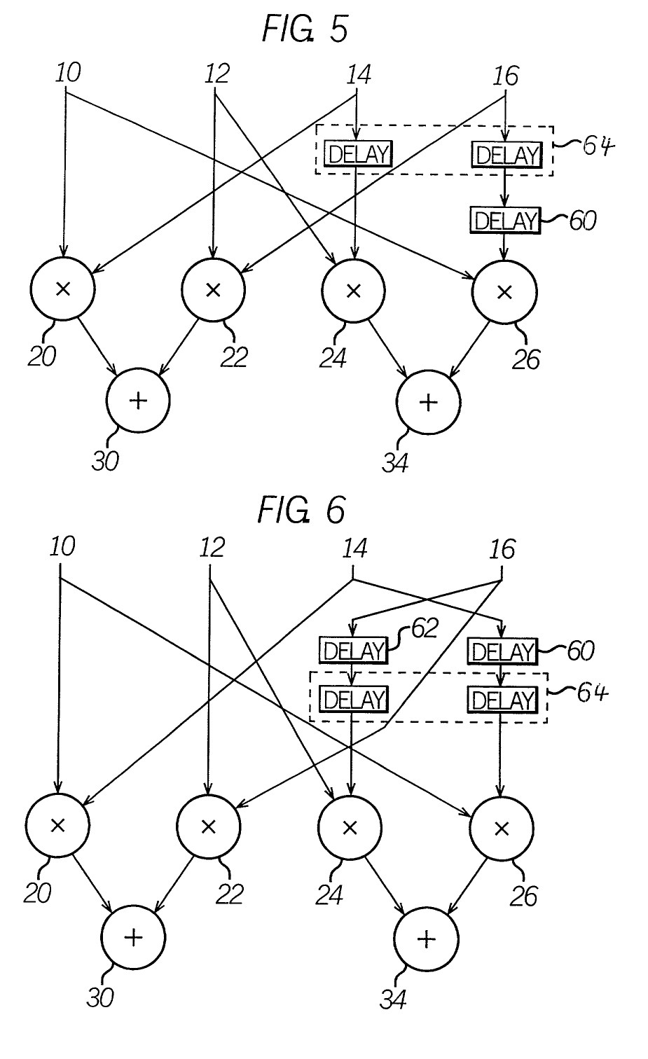

FIG. 5 shows part of the core processing unit for a 3:1 downsample filter;

FIG. 6 shows part of the core processing unit for a 4:1 downsample filter;

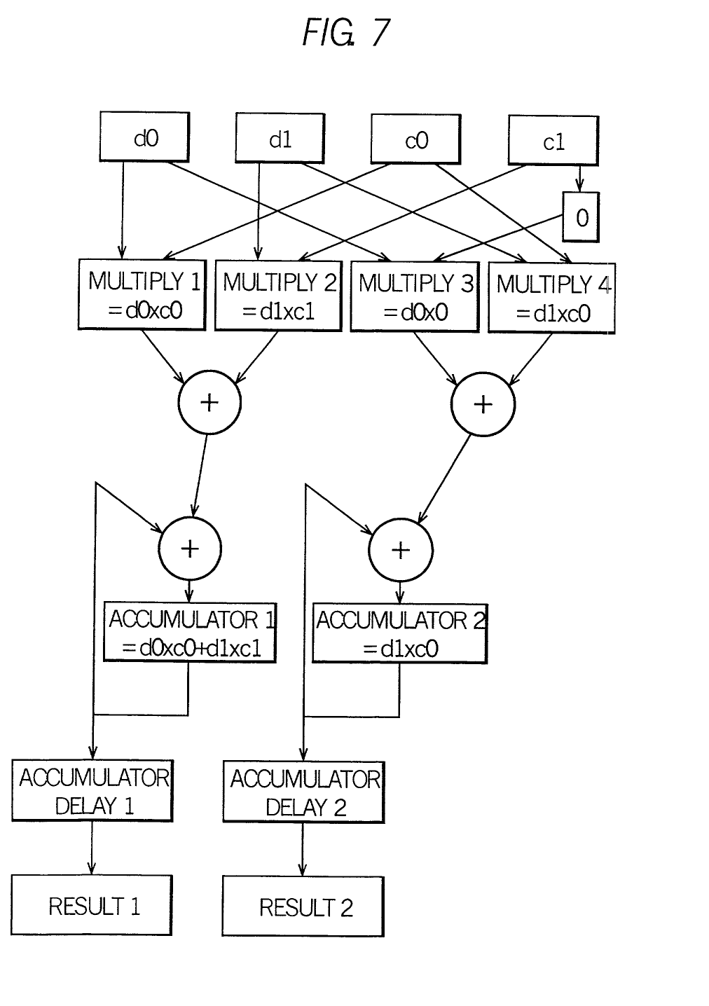

FIG. 7 shows the first stage of a worked example of a typical FIR operation;

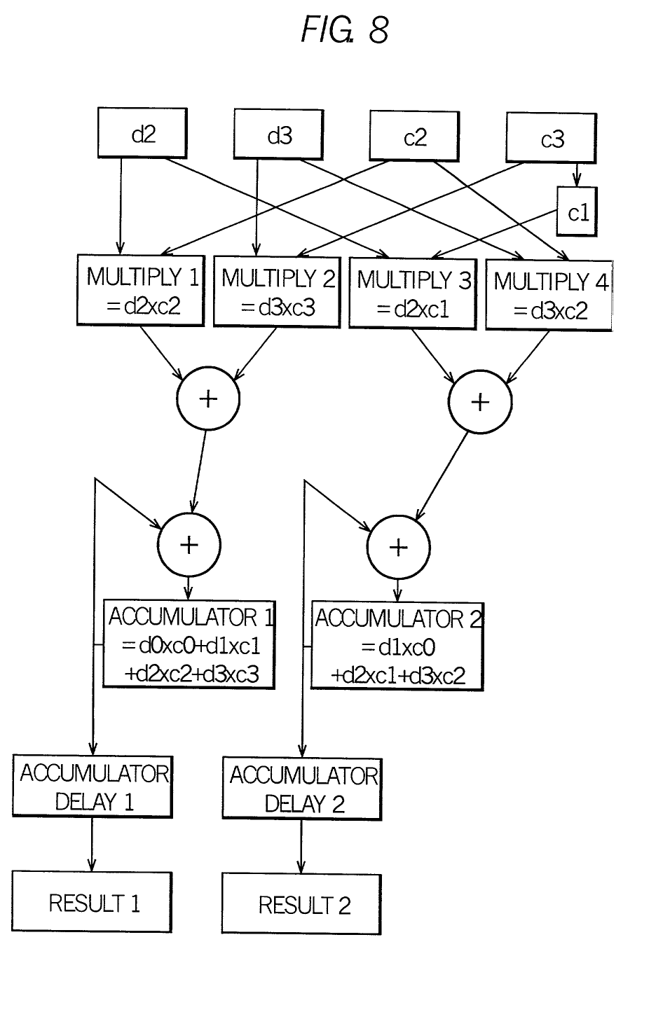

FIG. 8 shows the second stage of a worked example of a typical FIR operation;

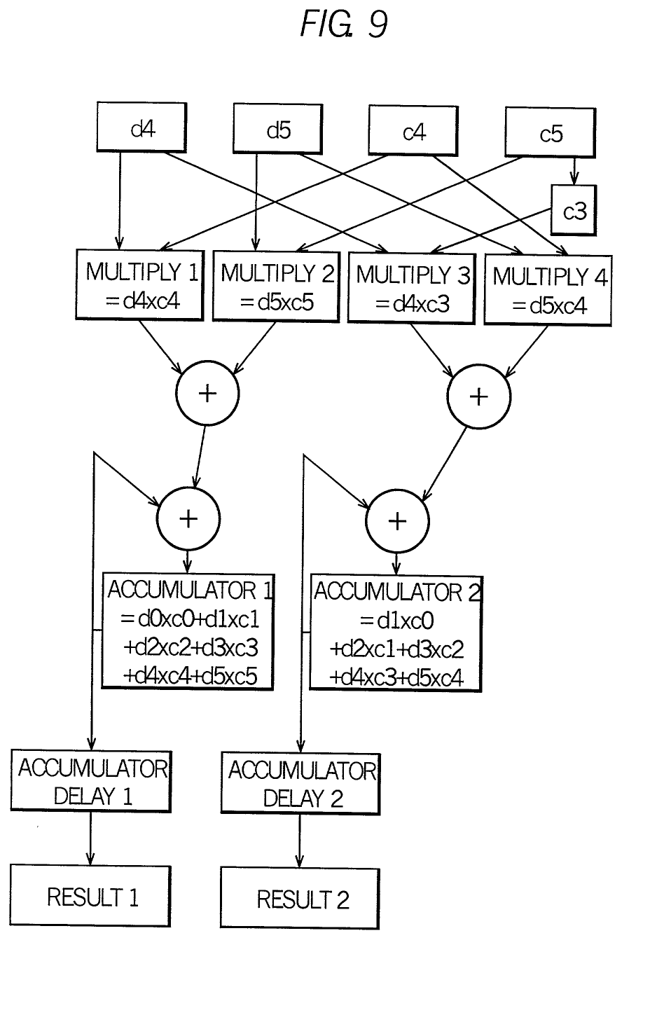

FIG. 9 shows the third stage of a worked example of a typical FIR operation; and

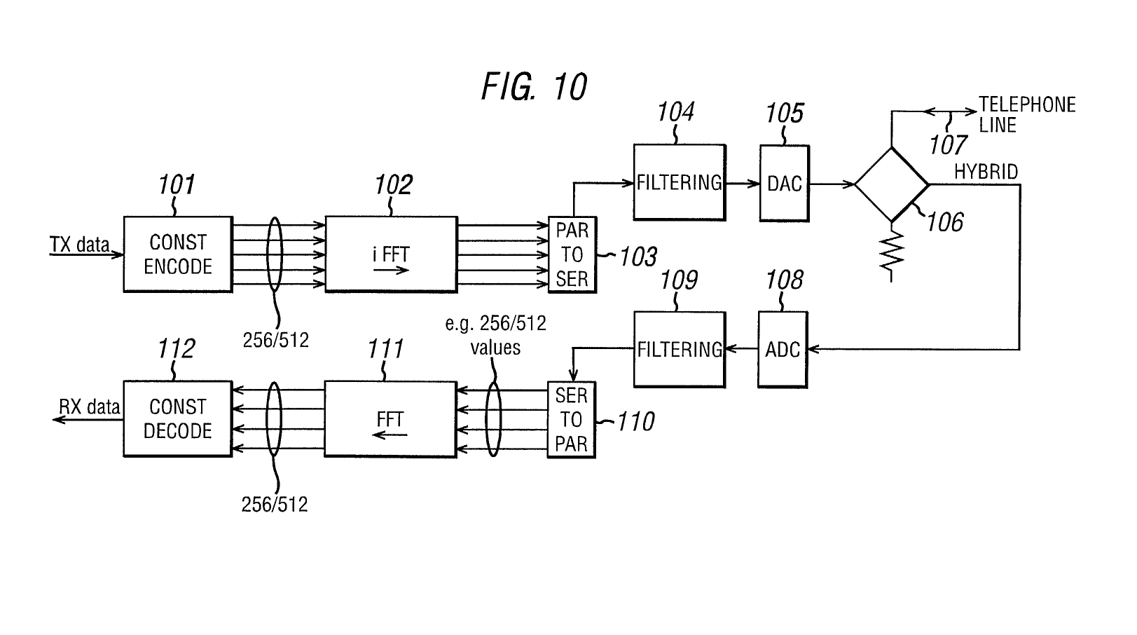

FIG. 10 is a schematic of an xDSL receiver/transmitter modem.

Referring to the drawings, FIG. 1 shows in overview the core processing unit of an embodiment where the processing unit is configured to implement an FIR filter function, the filter function being considered as the convolution of an input sample stream with a set of filter coefficients. In the processing unit, four multipliers 20, 22, 24 and 26 are provided, as well as two adders 30 and 34, and two accumulators 40 and 44. Additionally, a delay register 60 is connected to one of the inputs of the multiplier 24.

Sets of input values 10, 12 and filter coefficients 14, 16 are fed into the multipliers 20, 22, 24, 26 and delay register 60. The results of the multiplications are then summed by the adders 30, 34 and output to the accumulator units 40, 44.

As further sets of input values 10, 12 and filter coefficients 14, 16 pass through the system in this fashion, the two output values 50, 54 form in the accumulators 40, 44. When all the sets of input values and filter coefficients have been processed, the output values 50, 54 are then output by the processing unit.

FIG. 2 shows the core processing unit in more detail, as implemented in a digital signal processor (DSP). The processor includes a digital input four scalar values wide in the form of two memory banks 70, 72, each having two scalar values 10, 12 and 14, 16.

The DSP has index registers with auto-increment and with base/limit registers to perform automatic wraparound. It also has zero-overhead looping facilities.

In order to keep four multipliers fed when only four arguments (data values or coefficients) can be fetched each cycle, each argument is used twice.

FIG. 2 shows the four multipliers 10, 12, 14, 16, as well as a sequence of adders 30, 34, accumulators 40, 44 and delay registers 80, 84, which are employed to compute two digital outputs in registers 90 and 94.

FIG. 3 shows a variation of the preferred embodiment, in which the interconnections between the input values and coefficients 10, 12, 14, 16 and the multipliers 20, 22, 24, 26 are varied. Many such rearrangements of the input values and coefficients 10, 12, 14, 16, multipliers 20, 22, 24, 26, delays 60 and even adders 30, 34 are possible within the scope of the claimed invention, subject to the constraint that the inputs to the accumulators 40, 44 (shown in FIGS. 1 and 2) are unchanged.

In the following description, a filter is assumed to apply to real fractional data values d₀, d₁, d₂ ,etc. using filter coefficients c₀, C₁, C₂. . . Cₙ₋₁. The results of the filter are referred to as r₀, r₁, r_{2 . . .}

To further explain the principle of the invention, some typical applications will now be described, with reference to FIG. 2.

A simple 1:1 FIR

For an n-tap FIR, the results required are:

r₀=d₀×c₀+d₁×c₁+d₂×c₂+. . . +dₙ₋₁×cₙ₋₁

r₁=d₁×c₀+d₂×c₁+d₃×c₂+. . . +dₙ×cₙ₋₁

r₂=d₂×c₀+d₃×c₁+d₄×c₂+. . . +dₙ₊₁×cₙ₋₁

This can be done at 4 MACs/cycle. The two accumulators 40, 44 are used to evaluate two output values concurrently.

The multiplies are started as follows:

| cycle | acc1 | acc2 |
|---|---|---|
| 1 | acc1 = d₀ × c₀ + d₁ × c₁ | acc2 = d₀ × ο + d₁ × c₀ |
| 2 | acc1+ = d₂ × c₂ + d₃ × c₃ | acc2+ = d₂ × c₁ + d₃ × c₂ |
| 3 | acc1+ = d₄ × c₄ + d₅ × c₅ | acc2+ = d₄ × c₃ + d₅ × c₄ |
| . . . | | |
| (n + 1) ÷ 2 | acc1+ = | acc2+ = |
| | dₙ₋₁ × cₙ₋₁ + dₙ × ο) | dₙ₋₁ × cₙ₋₂ + dₙ × cₙ₋₁ |

In order to achieve this, the exact function of the ‘delay’ box 60 is that the value fed from arg2b 16 into the third multiplier 24 is delayed by one cycle. A more detailed walkthrough of this particular case is given below.

At this point we have computed r₀ and r₁. The housekeeping required before we can start on r₂ and r₃ is:

| | |
|---|---|
| Wait for the multiplies to complete | (pipelined, no cost) |
| Save r₀ and r₁ into a | (1 cycle) |
| circular data buffer | |
| Reset the coefficient input pointer | (no cost, index register does it) |
| Reset data input index register to | (1 cycle) |
| point to d₂ | |
| Clear accumulator | (no cost) |
| Loop control | (no cost, use zero-overhead loop) |

The actual multiplies take several cycles to complete, but a new one is started every cycle. The completion of the overall sequence is pipelined with the saving of the result and the starting of the next one.

These are typical steps in a DSP design and specifics of cycle usage are not relevant, since they have only been illustrated by way of example to show how various problems can be solved in established ways, so that pipelined multiplier startup/cooldown can become significant.

Overall, if n is odd then to do an n-tap filter takes (n+5)÷4 cycles per output value.

A 4:1 downsample (decimation) FIR

This example relates to a 4:1 decimation function, i.e. decimation factor d=4, but the following principles can be applied to other decimation factors, as discussed further below. Decimation produces fewer output values than there are input values and it does this by skipping forward more than one element in the input sequence, once each output is produced. The results required are:

r₀=d₀×c₀+d₁×c₁+d₂×c₂+. . . +dₙ₋₁×cₙ₋₁

r₁=d_{d}×c₀+d_{d+1}×c₁+d₃₊₂×c₂+. . . +d_{d+n-1}×cₙ₋₁

r₂=d_{2d}×c₀+d_{2d+1}×c₁+d_{2d+2}×c₂+. . . +d_{2d+n-1}×cₙ₋₁

The unit can do this at 4 MACs/cycle, but with an additional delay of d÷2 for every two results. This is achieved using a variable delay FIFO on the inputs to the multipliers 24, 26 that feed the second accumulator 44. This FIFO can be programmed for decimation factors of 2, 3 or 4. For decimation factors larger than 4, the rate goes down to 2 MACs/cycle.

FIGS. 3 to 6 provide schematics for embodiments of the 1:1, 2:1, 3:1 and 4:1 downsampling cases respectively. For the 2:1 case, illustrated in FIG. 4, an extra delay 62 is added, and the inputs to the multipliers 24 and 26 are rearranged with respect to the 1:1 case.

The architecture of the 3:1, 4:1 and subsequent orders of downsampling filter can easily be generated, by adding further delay units 64 (shown in FIGS. 4 and 5) to the basic structure of the 1:1 or 2:1 downsamplers for odd and even downsampling ratios respectively.

For example, the 3:1 downsampling filter (shown in FIG. 5) comprises the structure of the 1:1 filter (shown in FIG. 3) with an extra pair of delays 64 attached to the inputs 14 and 16. For a 5:1 downsampling filter (not shown), a further pair of delays is added in series with the first pair of delays 64 of FIG. 3, and so on. A corresponding method is followed for even downsampling ratios.

As stated above, in reality, a variable delay FIFO is employed instead of additional discrete delay pairs, but the principles are the same.

Returning to the specific example of a 4:1 downsampling filter, the two accumulators 40, 44 are used to evaluate two output values 50, 54 concurrently. The multiplies are started as follows:

| cycle | acc1 | acc2 |
|---|---|---|
| 1 | acc1 = d₀ × c₀ + d₁ × c₁ | acc2 = d₀ × 0 + d₁ × 0 |
| 2 | acc1+ = d₂ × c₂ + d₃ × c₃ | acc2+ = d₂ × 0 + d₃ × 0 |
| 3 | acc1+ = d₄ × c₄ + d₅ × c₅ | acc2+ = d₄ × c₀ + d₅ × c₁ |
| . . . | . . . | . . . |
| n ÷ 2 | acc1+ = dₙ₋₂ × cₙ₋₂ + dₙ₋₁ × cₙ₋₁ | acc2+ = dₙ₋₂ × cₙ₋₆ + dₙ₋₁ × cₙ₋₅ |
| (n ÷ 2) + 1 | acc1+ = dₙ × 0 + dₙ₊₁ × 0 | acc2+ = dₙ × cₙ₋₄ + dₙ₊₁ × cₙ₋₃ |
| (n ÷ 2) + 2 | acc1+ = dₙ₊₂ × 0 + dₙ₊₃ × 0 | acc2+ = dₙ₊₂ × cₙ₋₂ + dₙ₊₃ × cₙ₋₁ |

At this point we have computed r₀ and r₁. Housekeeping required before we can start on r₂ and r₃ is as for the 1:1 case.

Overall is n is even then to do an n-tap 2:1, 3:1 or 4:1 decimation filter takes 1+(n+5)÷4 cycles per output value.

For the downsample operations to flow in this way the precise operation of the ‘delay’ box 60 in FIG. 2 is slightly different.

For the 2:1 case, both arg2a 14 and arg2b 16 are delayed by 1 cycle. The delayed arg2a 14 is fed in to the third multiplier 24, and the delayed arg2b 16 is fed into the fourth multiplier 26.

For the 3:1 case, arg2a 14 is delayed by 1 cycle and arg2b 16 is delayed by 2 cycles. The delayed arg2a 14 is fed into the fourth multiplier 26. The delayed arg2b 16 is fed into the third multiplier 24.

For the 4:1 case, arg2a 14 and arg2b 16 are both delayed by two cycles. The delayed arg2a 14 is fed into the third multiplier 24. The delayed arg2b 16 is fed into the fourth multiplier 26.

The same rule can be used to generate suitable delay functions for any higher downsample ratios. At higher ratios, gradually longer delay lines are needed.

A 16:1 upsample (interpolation) FIR

An interpolation filter produces more outputs than there are inputs. In effect there is a two-dimensional array of coefficients rather than a single linear array. Each sequence of consecutive inputs is multiplied by a separate line of the coefficient array to produce each output.

With an interpolation factor of t the required results are:

r₀=d₀×c_{0,0}+d₁×c_{0,1}+d₂×c_{0,2}+. . . +dₙ₋₁×c_{0,n}

r₁+d₀×c_{1,0}+d₁×c_{1,1}+d₂×c_{1,2}+. . . +dₙ₋₁×c_{1,n}

. . . =

rₜ₋₁=d₀×c_{t-1,0}+d₁×c_{1-1,2}+. . . +dₙ₋₁×c_{t-1,n}

rₜ=d₁×c_{0,0}+d₂×c_{0,1}+d₃×c_{0,2}+. . . +dₙ×c_{0,n}

rₜ₊₁=d₁×c_{1,0}+d₂×c_{1,1}+d₃×c_{t-1,2}+. . . +dₙ×c_{t-1,n}

. . .

r_{2t-1,0}=d₂×c_{t-1,1}+d₃×c_{t-1,2}+. . . +dₙ×c_{t-1,n}

It is possible to work on two results at once for this filter, but only if the outputs computed are r₀ and rₜ. If we attempt to compute r₀ and r₁ together, we require too many distinct coefficients. For a suitable ordering of the elements of the coefficient array, the computation of r₀ and rₜ looks exactly like r₀ and r₁ for a simple 1:1 FIR. The only complication is that then the results must be placed 16 locations apart from each other in a circular buffer, assuming that the next stage after the interpolation filter cannot accept its inputs out of order. This requires an extra instruction for the output of the second result.

Overall, if n is odd then to do an n-tap interpolation filter takes 1+(n+5)÷4 cycles per output value.

A worked example of the 1:1 FIR

FIGS. 7 to 9 show the flow of values during consecutive clock ‘ticks’ in the case of the 1:1 FIR, in accordance with the values in the following table.

| cycle | acc1 | acc2 |
|---|---|---|
| 1 | acc1 = d₀ × c₀ + d₁ × c₁ | acc2 = d₀ × 0 + d₁ × c₀ |
| 2 | acc1+ = d₂ × c₂ + d₃ × c₃ | acc2+ = d₂ × c₁ + d₃ × c₂ |
| 3 | acc1+ = d₄ × c₄ + d₅ × c₅ | acc2+ = d₄ × c₃ + d₅ × c₄ |
| . . . | | |
| (n + 1) ÷ 2 | acc1+ dₙ₋₁ × cₙ₋₁ + dₙ × 0 | acc2+ = dₙ₋₁ × cₙ₋₂ + dₙ × cₙ₋₁ |

Thus, FIG. 7 shows the state of the processing unit in cycle 1; FIG. 8 shows the state of the processing unit in cycle 2, and FIG. 9 shows the state of the processing unit in cycle 3. As discussed above, it will take a total of (n+1)÷2 cycles to form the final two output values in the accumulators.

It should be noted that at the beginning of the computation of each output value, the two accumulators 40, 44 and the delay register 60 are reset.

The transfer of input values and filter coefficients between memory and the processor takes place in accordance with well-known practices, using standard features of the processor. Similarly, standard memory systems may also be employed, although relatively fast systems are preferred.

Processors adapted to perform FIR filtering in accordance with the invention can be used with advantage in an xDSL network interface module, e.g. they can be be incorporated in a chip which is designed for fast processing in a Discrete MultiTone (DMT) and Orthogonal Frequency Division Multiplex (OFDM) system, i.e. a DMT/OFDM transceiver. In xDSL systems, bits in a transmit data stream are divided up into symbols which are then grouped and used to modulate a number of carriers. Each carrier is modulated using either Quadrature Amplitude Modulation (QAM), or Quadrature Phase Shift Keying (QPSK) and, dependent upon the characteristics of the carrier's channel, the number of source bits allocated to each carrier will vary from carrier to carrier. In the transmit mode, an inverse Fourier transform is used to convert QAM modulated source bits into the transmitted signal. In the receive mode, inverse operations Fourier transforms are performed in the process of QAM demodulation.

As the invention makes a considerable saving in processing, several filtering operations can be carried out to obtain a improvement in signal quality. Typically more than one processor is provided in the interface module, and each performs one of the different filtering operations; however, each processor may perform more than one filtering operation at a time.

Referring to FIG. 10, this illustrates, in simplified form, a conventional xDSL modem where respective and separate FFT's and iFFT's are performed on reception and transmission data. In the system shown, transmission data (TX data) is supplied to an encoder 101, whereby samples (256/512) of data are input to an inverse fast Fourier transform filter 102. After performing iFFT's on the samples, they are supplied to a parallel to serial converter 103, which outputs serial data to filter circuits 104 connected to a digital/analogue converter (DAC) 105. The analogue data is then output to hybrid circuitry 106 for transmission by a telephone line 107.

When analogue data is received from the line 107, it is diverted, via hybrid circuitry 106, to an analogue/digital converter (ADC) 108, before being filtered by circuitry 109 and then supplied to a serial to parallel converter 110. Parallel data samples (256/512) are then subject to FFT's by circuitry 111 before being output to a decoder 12 which provides the decoded received data (RX data). The diagram has been simplified to facilitate understanding, since the system would normally includes far more complex circuitry; for example, cyclic prefix and asymmetry between TX and RX data sizes are not discussed here, because they are well known and do not form part of the invention. Moreover, the operation of such an xDSL modem is well known in the art, i.e. where separate iFFT and FFT is used respectively for streams of data to be transmitted and data which is received. With an xDSL signal for transmission on the telephone line 107, a sample stream output from the iFFT is upsampled in the filtering section 104 before symbols are passed onto the telephone line 107 via the DAC and the Hybrid. For example, the raw TX data is transmitted at 276 KHz and it is passed to a processor (embodying the invention) which acts as a 1:1 63-tap “Power Spectral Density” Filter, which ensures that the transmitted signal is not outside the PSD mask permitted by the Standard. Then, to adjust transmit gain setting, it is upsampled in another processor (embodying the invention) by effectively a 1-tap filter with 16:1 upsample to 4 MHz sample rate i.e. with 16 taps for each output value. Other filters which are used for the purposes of xDSL are not shown, but will be understood by those skilled in the art.

An xDSL signal received by the network interface module from the telephone line 7 is converted into an oversampled sample stream by the filtering section 109, which includes at least one processor (embodying the invention) in the 1:1 FIR filtering mode, and having appropriate filter coefficients. For example, received data arrives at 4 MHZ and is downsampled in a 4:1 70-tap downsample filter. Then, to adjust receive gain setting, the data is passed to another processor (embodying the invention) which is effectively a 1-tap filter 1:1 35-tap “Time Equalisation” filter (which compensates for various imperfections on the line). Finally, the sample stream is fed into the FFT and subsequently processed in order to extract the data encoded in the xDSL signal.

Although the use of the FIR filter has been described in detail with reference to an xDSL system, it may be used in any situation where filtering, downsampling, or upsampling is required, such as, for example, performing audio and speech processing in mobile telephony, or processing signals of any kind in communications systems. It may also be used in a network adaptor, or modem or computer. (The “term network adaptor” would cover, for example, any device for connecting a computer or other electronic device to a network (either a LAN such as Ethernet, or a wide area network (such as the Internet).

The invention also provides a computer program and a computer program product for carrying out any of the methods described herein, and a computer readable medium having stored thereon a program for carrying out any of the methods described herein.

1. A method of FIR filtering a series of real input values with a series of filter coefficients using a processor, the method comprising the steps of (a) loading each of the input values from memory into the processor, and (b) employing each of the loaded input values in the computation by the processor of more than one filter output value at a time, whereby the amount of data which needs to be transferred between memory and the processor is substantially reduced.

2. A method according to claim 1, wherein the more than one output values are consecutive.

3. A method according to claim 1 or 2, wherein a multiply-and-accumulate unit in the processor is used in the computation of one of the output values.

4. A method according to claim 3, further comprising the steps of (a) feeding one of the loaded filter coefficients into a delay register, and (b) using the output of the delay register as the input to the multiply-and-accumulate unit.

5. A method according to claims 3 or 4, wherein the output of the multiply-and-accumulate unit is pipelined.

6. A method according to any preceding claim, further comprising the step of multiplying each input value with more than one filter coefficient and adding the result of each multiplication to accumulators corresponding to the more than one output values.

7. A method according to any preceding claim, wherein two output values are computed at a time.

8. A method according to any preceding claim, further comprising the step of downsampling the input values.

9. A method according to claim 8 when dependent on claim 5, wherein at least one further delay register is used.

10. A method according to any of claims 1 to 7, further comprising the step of upsampling the input values.

11. A method according to claim 10, wherein the more than one output values computed at a time are separated by a number of samples corresponding to the upsampling factor.

12. A processor for FIR filtering a stream of real input values with a series of coefficients, comprising
a plurality of accumulators corresponding to a plurality of filter output values;
means for loading each of the input values and coefficients from memory;
means for performing simultaneous multiplications of the input value with at least some of the coefficients, and
means for adding the results of the multiplications to the respective accumulators,
wherein each loaded input value is used in the calculation of more than one filter output.

13. A processor for FIR filtering a stream of real input values with a series of coefficients, comprising
at least two pairs of multipliers;
at least one pair of adders, each adder connected to the outputs of one pair of multipliers;
at least one pair of accumulators, each accumulator corresponding to a filter output value and connected to the output of one of the adders; and
at least one delay register connected to the input of one of the multipliers, the delay register being connected to one of the multipliers,
wherein the input values are fed into the multipliers and delay register.

14. A processor comprising
a memory interface;
at least two pairs of multipliers;
at least one pair of adders, each adder connected to the outputs of one pair of multipliers;
at least one pair of accumulators, each accumulator corresponding to a filter output value and connected to the output of one of the adders; and
at least one delay register connected to the input of one of the multipliers, the delay register being connected to one of the multipliers,
wherein the memory interface is adapted to load input samples from memory into the inputs of the multipliers and the input of the delay register and store the output of the accumulators back in memory.

15. A processor according to any of claims 12 to 14, wherein the output of the accumulators is pipelined.

16. A processor according to any of claims 12-15, further comprising a variable-delay FIFO buffer connected to the input of at least one of the multipliers.

17. A processor according to any of claims 13 to 16, further comprising a second delay register, and wherein the processor downsamples the input stream.

18. A processor according to any of claims 12 to 16, wherein the processor upsamples the input stream.

19. A substrate having recorded thereon information in computer readable form for performing any of the methods in claims 1 to 11.

20. A network adaptor comprising a processor according to any of claims 12 to 18.

21. A computer comprising a processor according to any of claims 12 to 18.

22. A modem comprising a processor according to any of claims 12 to 18.
